(19) United States
(12) Patent Application Publication
(10) Pub. No.: US 2006/0249954 A1
(43) Pub. Date: Nov. 9, 2006

(54) Variable pneumatic structural element

(76) Inventor: Rolf Luchsinger, Uster (CH)

Correspondence Address: JENKENS & GILCHRIST, PC, 1445 ROSS AVENUE, SUITE 3200, DALLAS, TX, 75202, US

(21) Appl. No.: 10/554,192

(22) PCT Filed: Mar. 16, 2004
(86) PCT No.: PCT/CH04/00155

§ 371 Date: Apr. 17, 2006

(30) Foreign Application Priority Data
Apr. 23, 2003 (CH) 722/03

(51) Int. Cl. F16L 19/08

(52) U.S. Cl. 285/382.7

(57) ABSTRACT

Disclosed is a pneumatic structural element comprising a hollow body (1), at least two traction elements (4), two caps (5), at least two knots (3), and at least one compression rod (2). The length of the traction elements (4) of said pneumatic structural element can be pneumatically, hydraulically, or mechanically varied by Δl An actuator (11) or an actuation unit (12) is mounted between the ends of the traction elements (4) and one knot (3). The tensile stress in the traction elements (4) can be adapted to the circumstances by means of electronic control and regulation devices.

The present invention relates to means for varying the operating parameters in a pneumatic structural element according to the precharacterising part of claim 1.

Such pneumatic structural elements, hereinafter also referred to as “structural elements” are known per se, for example from WO 01/73245 (D1).

The structural element comprises, for example, a textile-reinforced flexible gas-proof hollow body. On the outside of said hollow body at least one compression rod, which extends along a surface line, is arranged so that said compression rod cannot buckle. At the ends of this compression rod two traction elements are attached which wind around the essentially tubular hollow body once in counter-direction to screw-in rotation and, at half the length of the hollow body, intersect on a surface line of the hollow body, which surface line is opposite that of the hollow body. The positions where the compression rod is connected to the traction elements are knots, into which the bearing forces are introduced. In this way no bending moments are introduced into the pneumatic structural element, except for those bending moments resulting from the working load—and the weight—of the structural element.

Means for varying the operating parameters of such structural elements are also already known from the patent application CH 2003 0494/03 (D2).

The structural element disclosed in D1 is associated with various disadvantages that manifest themselves during operation: during erection the structural element or a combination of several structural elements is/are impinged upon by compressed air by way of one or several valves, and subsequently retains/retain this quantity of compressed air. When viewed in isolation of any exterior loads, pressure in the hollow body, tensile stress in the traction elements, and compressive stress in the compression rod are the three significant operating parameters of the element. These operating parameters are defined by the geometry of the individual parts and by the initially selected operating pressure in the hollow body.

With the exception of the pressure in the hollow bodies, to the extent that said pressure is regulated by means of valves and pressure lines during the entire duration of operation, the values in the structural element that is not loaded remain essentially unchanged and cannot be matched to special operating states. The means for electrical variation of the operating parameters, which means have been disclosed in D2, comprise a device for electrothermal fluid-amplified hollow body overpressure change and from the use of electroactive materials to increase and reduce the stress on the traction elements and the compression elements or their length respectively.

It is the object of the present invention to create pneumatic structural elements with traction elements and compression elements whose operating parameters of hollow body overpressure and traction element stress and compression element stress can be varied, controlled and regulated in a simple manner and with proven pneumatic, hydraulic or mechanical means, either individually or simultaneously.

Such a control device is very advantageous, for example to even out any changes in compression, which changes result from temperature fluctuations; said control device makes possible automatic safety, energy, and form control of components and turns the structural element into an intelligent adaptive structure which can sensibly be adapted to the various circumstances which change due to varying operating parameters.

The solution of this task is provided in the characteristic part of claim 1 as far as its essential characteristics are concerned, and in the further claims as far as supplementary advantageous embodiments are concerned.

Apart from external loads or forces, temperature fluctuations normally have the main influence on the operating parameters. Meteorological and climatic conditions often result in temperature differences of ±20° C. and more within a short time. The magnitudes of parameter changes this causes are briefly illustrated below.

The interior pressure in the hollow body is subjected to the largest relative change. During a rise in temperature from 0° C. to 20° C., the pressure of a dry gas increases by approximately 7%, assuming the volume stays the same; during a rise to 30° C. by 11%. For a temperature difference of 20° C. the temperature-related expansion of a compression rod made of aluminium is 0.05% (for 10 m this results in an expansion of 5 mm).

For the traction elements which in a first approximation correspond to the length of the compression rod (for γ=L/D≈20), absolute changes in length of the same magnitude can be expected if steel cables are used. Depending on their type, fibre-reinforced plastics have a thermal expansion coefficient which is approximately twice that of aluminium, in any case greater than that of aluminium.

The most acute regulation requirement thus relates to the parameter of pressure in the hollow body, in particular because an increase in pressure at the same time results in an increase in the stress in the traction elements and thus also in the compression rod.

According to the ideal law of gas, in principle there are three options for regulating pressure: alter the volume, alter the quantity of gas, or alter the temperature.

The last-mentioned option plays a role, for example, in applications in space where there is no atmospheric gas to impinge upon the hollow body, and where the temperature can be regulated by providing more or less shade to the hollow body, and where thus solar energy can be used for heating. However, in most other cases it is easier and more favourable to regulate the pressure by altering the quantity of gas. This applies all the more so as the pressures in the pneumatic structural elements are not very high (<1 bar), so that the energy necessary for compressing the air is modest.

D2 discloses an example of regulating the pressure by altering the volume. It is of course possible to reduce the volume by placing a body, directly or in an envelope, solid or liquid, in the hollow body, thus increasing the pressure in the hollow body. However, such devices reduce the weight advantage of the structural element, or negate it altogether.

The method which in practical application remains for pressure regulation consists of insertion of a gas or of a mixture of gases to increase the pressure, and of letting the gas or mixture of gases out to reduce the pressure. To this effect the use of liquefied gases is imaginable. However, again, their use is expensive and therefore occurs only in space technology applications, where there is no atmosphere. In all other applications the most favourable solution consists of pumping ambient air into the hollow body by means of a compressor. It does not matter whether the compressor is integrated in the structural element or whether the compressed medium is distributed, controlled by valves by way of pressure pipes, to several structural elements. Moreover, it is of no importance how this compressor is operated. A thermal engine or an electric motor are imaginable. The average person skilled in the art is familiar with other energy sources to operate such a compressor or an air pump, and they are thus not further explained in this document.

By means of an electronic control and regulation device in conjunction with a pressure sensor the interior pressure in the hollow body can be kept within the selected pressure range. If the pressure sensor that is connected to the electronic regulation device senses that the elected maximum internal pressure of the hollow body is being exceeded then the electronic regulation device opens a drain valve and lets the required quantity of compressed air escape from the hollow body until the pressure is again within the selected pressure range. If the pressure is below the selected minimum pressure, the electronic regulation device causes the hollow body to be impinged upon by additional compressed air. This compressed air is for example provided by a receiver-type compressed air system or directly by a compressor. Supplementation of the above-described electronic regulation device with at least one temperature sensor arranged in or on the structural element also falls within the scope of the invention.

The subject of the invention is explained in more detail in several embodiments in the enclosed drawings.

The following are shown:

FIG. 1 an isometric view of a pneumatic structural element according to the state of the art;

FIGS. 2a, b, c diagrammatic views of a first embodiment of an actuator unit to handle extended regulating distances;

FIG. 3 a diagrammatic view of a second embodiment with variable-length traction elements;

FIG. 4 a diagrammatic view of a third embodiment with a variable-length compression rod; and

FIG. 5 a diagrammatic view of a fourth embodiment of an actuator unit with force reversal.

FIG. 1 is an isometric view of a pneumatic structural element according to the state of the art. It is designed from an essentially cylindrical gas-proof hollow body 1 of a length L, a diameter D, and comprises two caps 5. A compression rod 2 is tensioned between two knot elements 3. Also attached to said compression rod 2 are two traction elements 4 which extend in counter-direction to screw-in rotation around the hollow body 1 and rest firmly against said hollow body 1. The traction elements 4 intersect on a surface line 6 that is opposite the compression rod 2, at half the length of the cylindrical hollow body 1 at an intersection 7.

FIGS. 2 and 5 show actuator units 12 for altering the length of the traction elements or the length of the compression rod.

The following can be considered for use as actuators 11 to generate tension, either directly or as part of an actuator unit 12:

to generate compressive stress:

pressure bladder subjected to pressure. A flexible tight envelope is positioned between two end stops and pushes said end stops apart as soon as it is pressurised with a fluid;
hydraulic cylinder or pneumatic cylinder;
lead screw; and
rack and pinion combination.
   to generate tensile stress:
pressure bladder subjected to tension;
pneumatic artificial muscle (PAM), e.g. McKibben muscle;
implementation of rotation by means of a cable drive or chain drive;
lead screw; and
rack and pinion combination.

According to FIG. 5 variation of the stress per se can be caused either in the compression rod 2 or in the traction elements 4 using the same actuators 11. As diagrammatically shown in FIG. 5, with each traction actuator it is possible by means of a suitable mechanical force conversion to generate a compressive force, and vice versa. This can for example take place by overlapping the two connections 8, 9 which are moved towards each other, wherein a divergent movement (the two outside ends of the actuator 11 move away from each other) turns into a convergent movement (the two connections 8, 9 of the actuator unit 12 approach each other). The average person skilled in the art is familiar with the way this can be implemented in detail.

FIGS. 2a to 2c are diagrammatic views of a linear actuator unit 12 with two locking units 10a, b, an actual linear actuator 11 with a maximum regulating distance Δl and two connections 8, 9 which transmit the movement of the actuator 11. In this way very short regulating distances of linear actuators 11 can be used for extended movements. By combining stopping with actuator movement, the limited maximum regulating distance of any desired linear actuator 11 can be added up to form long overall regulating distances. This functions analogously to the principle of locomotion of a caterpillar.

FIG. 2a shows the actuator unit 12 in its home position. Both ends of the actuator 11 are removably fastened to the connection 8 by means of the locking devices 10a, b. To provide two concrete examples, fastening can take place by means of clamping devices or, if a toothed rack is attached to the connection 8, by means of braked pinions. Further options are known to the average person skilled in the art. In the next step the locking unit 10a is released and the actuator 11 is extended to its maximum length, as shown in FIG. 2b. Subsequently the locking unit 10a is fastened in the new position at the connection 8 and then the locking unit 10b is released. FIG. 2c shows the actuator unit 12 after the actuator 11 has been shortened to its minimum length. The locking device 10b can now be fastened. The actuator unit 12 has been shortened by the length Δl and is ready for another step. To control this procedure, an electronic control device and at least one sensor to determine the position of connection 8 relative to connection 9 is provided.

A first option for extending the compression rod 2 or the length between the two knot elements 3 consists of leaving the compression rod 2 unchanged per se, and to slide a knot element 3 along the compression rod 2, thus varying the effective length between the knots 3. Displacement of knot 3 can take place by means of rack and pinion, lead screw or by means of pneumatic or hydraulic cylinders.

A second option, shown in FIG. 4, consists of designing the compression rod 2 itself so that it is longitudinally adjustable. To this effect said compression rod 2 is at least divided in two, wherein these two parts are slidable relative to each other in axial direction by means of an actuator 11 or an actuator unit 12. Each of the knots 3 is non-positively connected to one of the parts of the compression rod. In the third embodiment, shown in FIG. 4, the actuator or an actuator unit 12 is attached directly to the knot element 3. If the actuator 11 is attached between a knot 3 and an end of the compression rod 2, then the compression rod 2 need not be designed in two parts. The dashed line shows the actuator 11 extended to its maximum by Δl. It is imaginable that the compression rod 2 itself is an actuator 11, e.g. in a cylinder-piston arrangement, in a rack and pinion combination or lead screw. To bring about a change in length of the compression rod 2, many additional embodiments and actuator arrangements are possible, and it is up to the average person skilled in the art to apply suitable means.

All the above-mentioned devices and constructions share a common feature, namely that the distance between the knot elements 3 that take up the bearing forces is varied. This must be taken into account in relation to the bearing arrangement and method of joining the structural elements in a construction.

FIG. 3 shows an example of the variation of the traction elements. The stress on the traction elements 4, of which there are at least two, is to be identical. This is to be taken into account when arranging the actuators 11. Either an actuator 11 is provided for each traction element 4, or, simpler and shown in FIG. 3, the traction elements 4 are bundled just in front of the knot 3 and are varied in the same direction with a single actuator 11 or an actuator unit 12. While this results in slight falsification of the force lead-in of the traction elements 4 in the knot 3, this does not pose a problem with relatively small actuator dimensions (see the above information relating to expansion merely in the per thousand range). The traction elements 4 shown in dashed lines and the actuator 11 in FIG. 3 show the state of the embodiment at maximum shortening of the actuator 11 around the length Δl.

To be able to control or regulate the variable compression rod 2 and the variable traction elements 4, they comprise stress sensors or length sensors. The sensors constantly measure the structural element's state of stress determined by external factors such as for example loads or the temperature, while the actuators, through interaction with a programmable electronic circuit make it possible to adapt to this state in a targeted manner.

The above-mentioned examples of varying the stress in the compression rod 2 and traction elements 4 clearly show that the stress can be varied both in the compression rod 2 and in the traction elements 4 according to the principle of “action equals reaction”. As a general rule, an operating value cannot be altered independently on its own. If one of the parameters is increased, then the other parameters also increase, and vice-versa. For example, if the traction elements 4 are shortened, they cut deeper into the hollow body 1, reduce the volume of said hollow body 1 and increase the interior pressure in the hollow body. At the same time the compressive stress in the compression rod 2 increases.

The stress in the compression rod 2 and in the traction elements 4 in a way represent an initial stress of the structural element in relation to taking up external forces and loads.

Increasing a parameter thus increases the rigidity of the structural element as a whole, provided the increase does not result in exceeding a maximum tension or the maximum pressure.

1. A pneumatic structural element
comprising an elongated airtight hollow body (1) that can be impinged upon by compressed air and is made of a flexible material,
comprising at least one compression rod (2) which along a surface line of the hollow body (1) rests against said hollow body and is secured against displacement and buckling, furthermore
comprising at least one pair of traction elements (4) which are attached to the two ends of the compression rod (2), of which there is at least one, for which purpose each end of the compression rod (2) has a knot (3) for mutual non-positive attachment of compression rod (2) and traction elements (4) and for taking up bearing forces, wherein furthermore the two traction elements (4), of which there are at least two, in at least one turn are helically placed around the hollow body (1) in opposite directions and intersect on a surface line (7) of the hollow body (1), which surface line is opposite the compression rod (2),
characterised in that
means are provided by which at least one of the operating parameters of pressure in the hollow body (1), length of the compression rod (2), or length of the traction elements (4) can be altered pneumatically, hydraulically or mechanically.

2. The pneumatic structural element according to claim 1, characterised in that
means are provided by which the length of the compression rod (2) can be altered pneumatically, hydraulically or mechanically.

3. The pneumatic structural element according to claim 2, characterised in that
the length of the compression rod (2) is altered by means of one of the following actuators (11) or actuator units (12), namely by means of:
a pressure bladder subjected to pressure
or a hydraulic cylinder
or a pneumatic cylinder
or a lead screw
or a rack and pinion combination;
or in conjunction with force reversal by means of
a pneumatic artificial muscle
or a cable drive
or a chain drive;
or by means of a linear actuator unit (12) which by means of two locking devices (10), which can be operated in turn, on both ends of a linear actuator (11), can overcome multiples of the maximum regulating distance of this linear actuator (11).

4. The pneumatic structural element according to claim 1, characterised in that
means are provided by which the length of the traction elements (4) can be altered pneumatically, hydraulically or mechanically.

5. The pneumatic structural element according to claim 4, characterised in that
the length of the traction elements (4) is varied by means of one of the following actuators (11) or actuator units (12), namely by means of:
a pneumatic artificial muscle
or a cable drive
or a chain drive
or a lead screw
or a rack and pinion combination;
or in conjunction with force reversal by means of
a pressure bladder subjected to pressure
or a hydraulic cylinder
or a pneumatic cylinder
or by means of a linear actuator unit (12) which by means of two locking devices (10), which can be operated in turn, on both ends of a linear actuator (11), can overcome multiples of the maximum regulating distance of this linear actuator (11).

6. The pneumatic structural element according to claim 1, characterised in that
means are provided by which compressed air can be supplied to, or removed from, the hollow body (1).

7. The pneumatic structural element according to claims 1 to 6, characterised in that
sensors for measuring the variable operating parameters of interior pressure in the hollow body, length or stress of the compression rod (2) or length or stress of the traction elements (4) are present, as well as in that
an electronic control and regulating device is present.

8. The pneumatic structural element according to claims 3 and 6.

9. The pneumatic structural element according to claims 5 and 6.

10. The pneumatic structural element according to claims 3, 5 and 6.
